(19) United States
(12) Patent Application Publication
(10) Pub. No.: US 2026/0010235 A1
(43) Pub. Date: Jan. 8, 2026

(54) KNOWLEDGE REPRESENTATION AND MANAGEMENT IN A VIRTUAL REALITY ENVIRONMENT

(71) Applicant: MemoryLabs LLC, New Canaan, CT (US)

(72) Inventors: John Jien Kao, New Canaan, CT (US); Craig Matthew Trim, Ventura, CA (US); Kaifeng Wu, Los Angeles, CA (US)

(73) Assignee: MemoryLabs LLC, New Canaan, CT (US)

(21) Appl. No.: 18/765,551

(22) Filed: Jul. 8, 2024

(51) Int. Cl. G06F 3/01; G06T 19/00; G09B 5/02

(52) U.S. Cl. CPC G06F 3/017; G06T 19/003; G09B 5/02; G06T 2210/36

(57) ABSTRACT

An embodiment constructs a three-dimensional graph representing a corpus of knowledge. The three-dimensional graph includes nodes and connections coupling one node to at least another node. The embodiment presents visually, in a virtual three-dimensional space representation in a virtual reality (VR) environment, a first view of the three-dimensional graph. The embodiment adjusts, responsive to detecting a first gesture, the first view of the three-dimensional graph, the adjusting causing a change in a subset of the set of nodes. The change causes a representation, in the VR environment, of the first node to change to a new representation indicative of a different level of detail of the first node from the representation.

### BACKGROUND

The present invention relates generally to knowledge representation and management. More particularly, the present invention relates to a method, system, and computer program for knowledge representation and management in a virtual reality environment.

Knowledge representation involves representing information about the physical world in a computerized form that helps a computer system or a human user organize information or perform a task. One example of a knowledge representation is a knowledge graph, in which each node of the graph represents an item, such as a fact or concept, and each edge of the graph, connecting two or more nodes together, represent a relationship between the connected nodes.

Some knowledge representations make use of a virtual reality environment. Virtual reality, or VR, is a simulated environment, often three-dimensional (3D), that lets a user explore and interact with computer-generated elements in a way that approximates the real or physical world. For example, a user exploring art history might, in a VR environment, be able to view or rearrange images of paintings in a simulated art gallery, or virtually “walk around” a rendering of a sculpture to experience the sculpture from multiple viewpoints.

A user often interacts with items in the VR environment using one or more predefined gestures, which are sensed by one or more gesture recognition sensors coupled to a computer system implementing the VR environment. Some examples of presently available gesture recognition sensors are based on infrared-based dynamic optical sensors, use time of flight camera-based systems, or are based on directional photodiodes sensing infrared energy emitted from an integrated light emitting diode (LED) and converting the measurements of reflected infrared energy into information about physical motion. For example, to rearrange images of paintings in a simulated art gallery, a user might move her physical hand until a virtualized image of two fingers of her hand touches an image of a painting, and move her physical hand to drag the image of the painting to a desired location in the VR environment.

### SUMMARY

The illustrative embodiments provide for knowledge representation and management in a virtual reality environment. An embodiment includes constructing a three-dimensional graph representing a corpus of knowledge, the three-dimensional graph comprising a set of nodes and a set of connections, a first connection in the set of connections coupling a first node in the set of nodes to at least one second node in the set of nodes. An embodiment includes presenting visually, in a virtual three-dimensional space representation in a virtual reality (VR) environment, a first view of the three-dimensional graph. An embodiment includes adjusting, responsive to detecting a first gesture, the first view of the three-dimensional graph, the adjusting resulting in a second view of the three-dimensional graph in the VR environment, the adjusting causing a change in a subset of the set of nodes, the subset of nodes including the first node, wherein the change causes a representation, in the VR environment, of the first node to change to a new representation of the first node, wherein the new representation of the first node is indicative of a different level of detail of the first node from the representation. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for knowledge representation and management in a virtual reality environment in accordance with an illustrative embodiment;

FIG. 3A depicts a first phase of an example of knowledge representation and management in a virtual reality environment in accordance with an illustrative embodiment;

FIG. 3B depicts a second phase of an example of knowledge representation and management in a virtual reality environment in accordance with an illustrative embodiment;

FIG. 3C depicts a third phase of an example of knowledge representation and management in a virtual reality environment in accordance with an illustrative embodiment;

FIG. 4 depicts another example of knowledge representation and management in a virtual reality environment in accordance with an illustrative embodiment;

FIG. 5A depicts a first phase of another example of knowledge representation and management in a virtual reality environment in accordance with an illustrative embodiment;

FIG. 5B depicts a second phase of another example of knowledge representation and management in a virtual reality environment in accordance with an illustrative embodiment;

FIG. 5C depicts a third phase of another example of knowledge representation and management in a virtual reality environment in accordance with an illustrative embodiment;

FIG. 5D depicts a fourth phase of another example of knowledge representation and management in a virtual reality environment in accordance with an illustrative embodiment; and

FIG. 6 depicts a flowchart of an example process for knowledge representation and management in a virtual reality environment in accordance with an illustrative embodiment.

### DETAILED DESCRIPTION

The illustrative embodiments recognize that presently available knowledge representation systems lack sufficient support for three-dimensionality, user customization, a user guidance element, or gesture support, or are insufficiently intuitive for users. Thus, the illustrative embodiments recognize that there is a need for an improved knowledge representation system that leverages three-dimensionality and gesture control to provide a more immersive, intuitive, and intelligent experience, and better facilitates information synthesis, than presently available knowledge representation systems.

The present disclosure addresses the deficiencies described above by providing a process (as well as a system, method, machine-readable medium, etc.) that constructs a three-dimensional graph including nodes and connections and representing a corpus of knowledge; presents visually, in a virtual three-dimensional space representation in a VR environment, a first view of the three-dimensional graph; and adjusts, responsive to detecting a first gesture, the first view of the three-dimensional graph, the adjusting causing a representation, in the VR environment, of the first node to change to a new representation of the first node. Thus, the illustrative embodiments provide for knowledge representation and management in a virtual reality environment.

An illustrative embodiment constructs a graph representing a corpus of knowledge. In one embodiment, the graph is two-dimensional. In another embodiment, the graph is three-dimensional. The graph includes a set of nodes. The graph also includes a set of connections (i.e., graph edges) coupling a node in the set of nodes to at least one other node. In the graph, a node represents, for non-limiting example, a document, image, video, portion of audio, a comment on a document, image, video, portion of audio, or another form of content, a posting or threaded conversation on a social media platform or message exchange application, an avatar representing an entity or user, a three-dimensional model, a database, a fact or concept, a gateway to another graph representing another corpus of knowledge, or another item or type of content. In addition, nodes need not all represent the same type of item. For example, one node might represent a document while another node might represent a video. As well, a dock node is a node representing both the node itself and other nodes connected to the node, such as comments, recorded content, discussions, and guidance features. A connection represents a relationship between the items represented by two nodes. For example, for a corpus of art history knowledge, individual nodes might represent individual paintings or sculptures, a video of a professor explaining and demonstrating a particular painting technique, a movie depicting the life of the painter Pablo Picasso, a court decision involving a Picasso sculpture, a Uniform Resource Locator (URL) pointing to a website selling posters of famous paintings by Picasso, and a syllabus for a college-level Introduction to Art History course. Techniques for extracting data from a corpus of knowledge, and constructing a graph include nodes and connections, are presently available.

An embodiment adds additional nodes and connections to the graph, periodically or in response to additions or updates to the corpus of knowledge (e.g., a newly-published book, newly-obtained image of a painting, or three-dimensional model of a physical object), material obtained from another source (e.g., a dataset or content accessible via a communications network such as the internet) automatically or in response to a query, information generated from user activity within an embodiment, and the like.

An embodiment generates a first view of the graph and presents the first view visually, in a virtual three-dimensional space representation in a virtual reality (VR) environment. A node in the first view is depicted at a selected level of detail. In one embodiment, a color-coding scheme is used to depict particular types of connections in the first view. For example, in a first view of nodes and connections representing a corpus of art history knowledge, blue might be used to depict connections between nodes representing artworks by the same artist. In another embodiment, audio, visual, or audio-visual sounds, icons, or other indicators or combinations of indicators are used to depict particular types of connections in the first view or a particular path among connections in the first view.

An embodiment organizes nodes and their connections according to a multi-dimensional weighting system or scheme. In one embodiment, one dimension of a multi-dimensional weighting system is time, enabling node organization according to when the item represented by a node was created or modified, when the node itself was created or modified, or another time-based organizational scheme.

In an embodiment, the first view organizes nodes and their connections in a three-dimensional arrangement around a user in a VR environment. Some non-limiting examples of three-dimensional arrangements are the presently available dandelion, spherical, and galaxy or nebula arrangements. For example, in a first view of nodes and connections representing a corpus of art history knowledge, nodes representing artworks might be depicted at distances in the VR environment from a user, with the distances corresponding to the age of the artworks. Thus, a depiction of a node representing a cave painting might appear to be furthest away from a user, a depiction of a node representing a classical Greek sculpture might appear to be in a medium distance from the user, and a depiction of a node representing a movie finished last week might appear to be closest of the three representations to the user.

In some embodiments, the first view is organized according to a use case. Some non-limiting examples of uses case are a user's role definition (e.g., knowledge curator, knowledge owner, knowledge designer, knowledge consumer), a security or access management category of the user or data in the corpus of knowledge, a training use case, a consulting use case, a brainstorming use case, and a use case involving a collaboration between two or more users.

An embodiment uses one or more gesture recognition sensors and a presently available technique to detect a gesture performed by a user. One non-limiting example of a presently available gesture is a user moving her physical hand until a virtualized image of two fingers of her hand touches an image representing a node, and moving her physical hand to drag the image to a desired location in the VR environment. Other finger-based gestures, such as selecting, dragging, zooming in (by expanding a distance between a thumb and another finger), zooming out (by shortening a distance between a thumb and another finger), and three-finger gestures recognized using a trackpad or another gesture recognition sensor, are also presently available. One embodiment recognizes a two-handed gesture, in which moving a pinched-together thumb and another finger, in each hand, apart from each other invokes a zoom in and moving a pinched-together thumb and another finger, in each hand, towards each other invokes a zoom out. A pinched-together thumb and finger refers to a configuration in which a thumb is held in contact with another finger of the same hand. Another embodiment recognizes a one-handed gesture, in which rotating a hand from an open palm-down position to an open palm-up position invokes a guidance or help function described elsewhere herein. Other gestures, and the commands such gestures invoke, are also possible and contemplated within the scope of the illustrative embodiments.

An embodiment adjusts the first view of the graph, resulting in a second view of the graph in the VR environment. In an embodiment, the adjusting causes a change in a subset of the set of nodes, causing a representation, in the VR environment, of a node to change to a new representation of the node, or causing a representation, in the VR environment, of a connection to change to a new representation of the connection. In one embodiment, the adjusting causes a new representation of a node, indicative of a different level of detail (i.e., more detail or less detail) of the node from the initial representation of the node. For example, in a “zoomed in” state, the most important nodes based on the current context might be displayed at a higher level of detail, while the rest of the nodes might be displayed at a lower level of detail. As another example, in a “zoomed out” state, most of the nodes might be displayed at an intermediate (i.e., between high and low) level of detail.

To determine the relative information level for a node for a given zoom level, an embodiment analyzes the context of the current node representation, including the user's previous interactions, the current focus area, and the overall structure of the knowledge graph. This analysis helps determine the nodes most relevant to the user's current task or query. In particular, an embodiment assigns an importance score to one or more nodes in the knowledge graph based on various factors, such as the node's centrality in the graph, the node's frequency of access or interaction by the user or a subset of all the embodiment's users, and the relevance of the node's content to the user's current query or interest. The node importance score prioritizes which nodes have the highest displayed detail. To incorporate a node's frequency and recency of access by a user, an embodiment weights node access data using a weighted moving average (WMA) algorithm to emphasize more recent interactions. In particular, an embodiment computes a WMA value at a particular time t by dividing the sum (for all i from 1 to n) of all wᵢxᵢ by the sum (for all i from 1 to n) of all wᵢ, where wᵢ represents the interaction data points, xᵢ represents the weights (with more recent interactions given higher weights), and n is the number of data points. To determine a user's current focus area, an embodiment examines the specific part of the knowledge graph that the user is currently exploring, including tracking the user's navigation path and identifying clusters of nodes that are closely related to the user's current focus using the presently available Louvain method for community detection in networks. The Louvain method computes (½m)*sum([Aᵢⱼ−kᵢkⱼ/2m)*δ(Cᵢ, Cⱼ)), where Aᵢⱼ is an adjacency matrix storing adjacency of nodes in the knowledge graph, kᵢ and kⱼ are the degrees of nodes i and j, m is the number of edges, Cᵢ and Cⱼ are the communities of nodes i and j, δ( ) represents the Kronecker delta function, and sum( ) is the summation function, for all i and j. To perform task and query analysis, an embodiment considers the user's current task or query context, such as a search query, the type of analysis being performed, or specific learning objectives of the user. One embodiment uses a presently available term frequency-inverse document frequency (TF-IDF) algorithm to identify relevant nodes. To compute a node importance score, embodiments use presently available graph theory metrics such as degree centrality, betweenness centrality, and closeness centrality to determine the structural importance of each node within the graph. For example, betweenness centrality C_{B}(v) is calculated as the sum of σₛₜ(v)/σₛₜ, for all s not equal to t not equal to v, where σₛₜ is the total number of shortest paths from node s to t, and σₛₜ(v) is the number of those paths that pass through node v. Another embodiment calculates an importance score based on how often each node has been accessed or interacted with by users. Nodes with higher interaction frequencies are considered more important. Another embodiment uses a presently available machine learning algorithm such as a support vector machine, to assess the relevance of a node based on content similarity, by content represented by the node, to a user's query or area of interest.

An embodiment maps the calculated node importance scores to different levels of detail based on the current zoom level of the graph representation. For instance, at a high zoom level (zoomed out), only the most critical nodes and their primary connections are shown. At a low zoom level (zoomed in), more detailed information about each node, including secondary connections and metadata, is displayed. In one embodiment, as a user zooms in, additional details such as node metadata, secondary connections, and related content are incrementally revealed using a logarithmic scale function, for example DetailLevel(z)=log(1+β_{z}), where z is the zoom level and β is a scaling factor. An embodiment periodically adjusts the detail level of the nodes as the user zooms in or out, ensuring that the most relevant information is always prominently displayed. One embodiment performs node importance scoring and view adjustment in real time, in response to a detected user gesture detected by the VR system or other user input. One embodiment allows a user to customize the criteria for determining node importance and information levels, and specify preferences for how information is displayed. An embodiment incorporates user feedback to refine importance scoring and detail level mapping. For example, one embodiment utilizes one or more presently available supervised or unsupervised learning techniques, such as k-means clustering, to analyze patterns in user interactions with the knowledge graph. To render the three-dimensional graph in the VR environment, one embodiment uses a presently available visualization engine able to render a knowledge graph with thousands of nodes and connections in real time or near real time.

In another embodiment the new representation of the node is indicative of a change in status of the node (e.g., more data relating to the node has been added to the corpus). In another embodiment, the adjusting causes a new representation of a connection, indicative of a change in a status of the connection. In one embodiment, a change in a status of the connection has occurred because a new connection has been formed between nodes, or more data relating to the connection has been added to the corpus. In another embodiment, a change in a status of the connection has occurred due to a navigational inference, such as a user's node-to-node traversal history in the graph along connections including the connection, or navigation along the connection is being suggested by a user guidance function described elsewhere herein. In another embodiment, the resulting view visually presents a result of an analysis, using a presently available technique and one or more presently available learning or navigation metrics, of the user's navigation through one or more nodes. In another embodiment the new representation of the node is indicative of a specific type of node. One embodiment defines specific rules for different content types within the nodes. For example, document nodes might reveal summaries or excerpts at intermediate zoom levels, while image nodes might show thumbnails or high-resolution versions. Another embodiment organizes content hierarchically, displaying higher-level categories or summaries at comparatively zoomed-out levels and detailed subcategories or full content at comparatively zoomed-in levels. One embodiment adjusts the visibility and detail level of nodes based on the user's role and access permissions. For example, administrators might see more comprehensive metadata and control options than non-administrators. One embodiment adjusts the node detail levels and connections displayed based on the user's specific tasks or roles, such as knowledge curation, data analysis, or content consumption. One embodiment uses visual cues such as highlighting, color coding, and size adjustments to emphasize the most important nodes at each zoom level. One embodiment provides interactive annotations and tooltips that offer additional context and information when the user hovers over or selects a node.

In one embodiment, the second view of the graph in the VR environment is a result of merging two views or portions of views. In one embodiment, a human expert (e.g., a knowledge facilitator), merges two views according to a desired outcome (e.g., a learning or brainstorming objected). In another embodiment, a trained machine learning model uses a presently available technique to merge views based on the data represented in each view.

An embodiment adjusts the first view of the graph responsive to detecting a gesture. In embodiments, the gesture invokes selection of a node, a drag gesture repositioning a node within a virtual three-dimensional space representation in a VR environment, a navigation gesture along a connection, a user interface that activates when a user looks at his or her palm, with a particular action assigned to a particular location on the user's hand and activated by tapping the location, or another presently available gesture supported by a user interface. In another embodiment, the gesture is a two-handed gesture, invoking a zoom in or out, as described elsewhere herein. In another embodiment, an orientation of the gesture corresponds to an orientation along which a level of detail of one or more nodes is changed. In another embodiment, the gesture invokes a guidance or help function.

An embodiment includes a user guidance or help function. In embodiments, the user guidance function provides one or more of a connection creation function, a node or connection curation function, a node or connection rearrangement function, a tour guide function, a function generating a summary or context of content or datasets represented by nodes along a traversed path or within a defined portion of the system, an import function including recommending and forming new nodes and connections representing imported data, a merge function merging nodes and connections representing two corpuses of knowledge, and a conflict resolution function resolving import and merge conflicts. In one embodiment, the user guidance function includes an animation function that, when invoked, indicates a node, a relationship between nodes, a next node recommendation from a currently selected node, or another animation guiding a user in exploration of the nodes and connections based on a user-defined criterion. In one embodiment, a user preference setting controls a degree of scriptedness versus randomness provided by the user guidance function's recommendations. For example, if the user preference setting is set to the maximum scriptedness value, the user guidance function's recommendations might include only the most likely recommendation, based on the user's or a group of other users' past actions. On the other hand, if the user preference setting is set to the minimum scriptedness value (i.e., maximum randomness), the user guidance function's recommendations might include only randomly generated recommendations, generated using a pseudo-random number generator, a presently available technique. In embodiments, a user or machine learning model sets the user preference setting.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

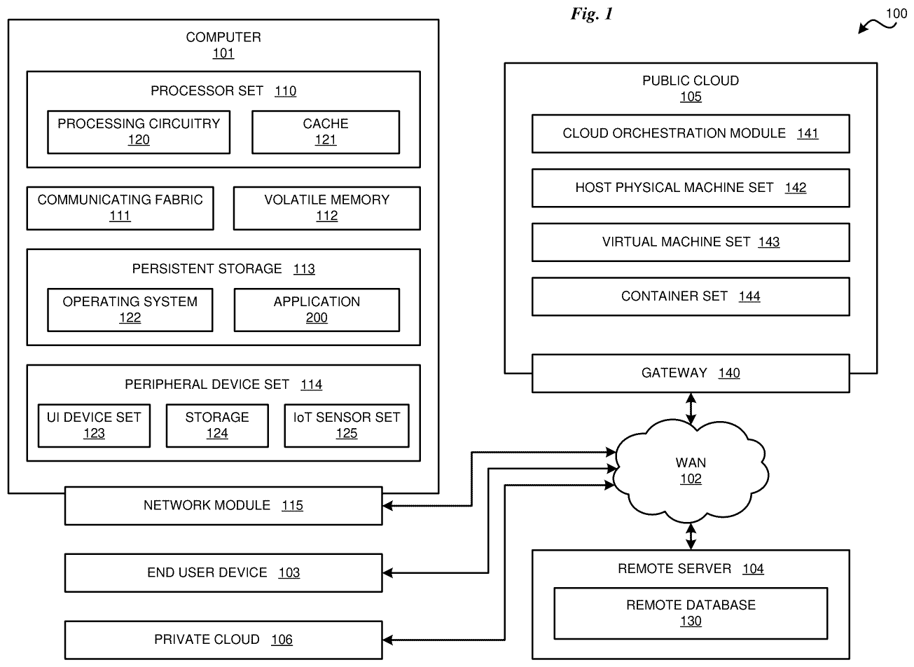

With reference to FIG. 1, this figure depicts a block diagram of a computing environment 100. Computing environment 100 contains an example of an environment for the execution of at least some of the computer code involved in performing the inventive methods, such as application 200 implementing knowledge representation and management in a virtual reality environment. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

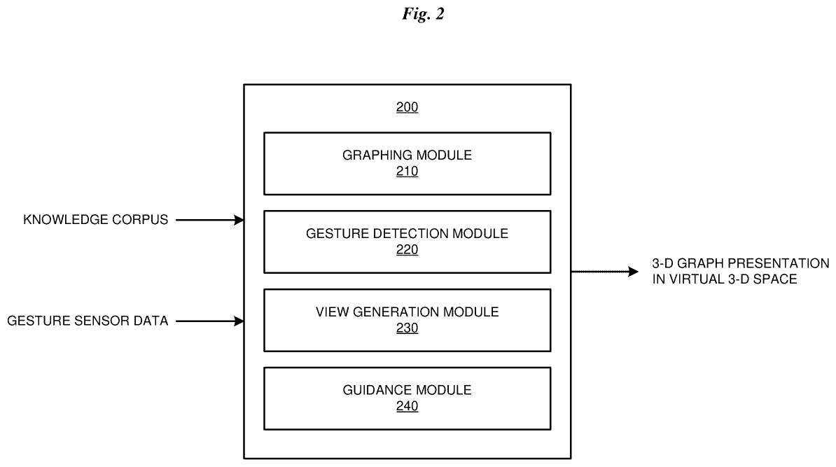

With reference to FIG. 2, this figure depicts a block diagram of an example configuration for knowledge representation and management in a virtual reality environment in accordance with an illustrative embodiment. Application 200 is the same as application 200 in FIG. 1.

In the illustrated embodiment, graphing module 210 constructs a graph representing a corpus of knowledge. In one implementation of module 210, the graph is two-dimensional. In another implementation of module 210, the graph is three-dimensional. The graph includes a set of nodes. The graph also includes a set of connections (i.e., graph edges) coupling a node in the set of nodes to at least one other node. In the graph, a node represents, for non-limiting example, a document, image, video, portion of audio, a comment on a document, image, video, portion of audio, or another form of content, a posting or threaded conversation on a social media platform or message exchange application, an avatar representing an entity or user, a three-dimensional model, a database, a fact or concept, a gateway to another graph representing another corpus of knowledge, or another item or type of content. In addition, nodes need not all represent the same type of item. For example, one node might represent a document while another node might represent a video. As well, a dock node is a node representing both the node itself and other nodes connected to the node, such as comments, recorded content, discussions, and guidance features. A connection represents a relationship between the items represented by two nodes. For example, for a corpus of art history knowledge, individual nodes might represent individual paintings or sculptures, a video of a professor explaining and demonstrating a particular painting technique, a movie depicting the life of the painter Pablo Picasso, a court decision involving a Picasso sculpture, a Uniform Resource Locator (URL) pointing to a website selling posters of famous paintings by Picasso, and a syllabus for a college-level Introduction to Art History course. Techniques for extracting data from a corpus of knowledge, and constructing a graph include nodes and connections, are presently available.

Module 210 adds additional nodes and connections to the graph, periodically or in response to additions or updates to the corpus of knowledge (e.g., a newly-published book, newly-obtained image of a painting, or three-dimensional model of a physical object), material obtained from another source (e.g., a dataset or content accessible via a communications network such as the internet) automatically or in response to a query, information generated from user activity within an embodiment, and the like.

View generation module 230 generates a first view of the graph and presents the first view visually, in a virtual three-dimensional space representation in a virtual reality (VR) environment. A node in the first view is depicted at a selected level of detail. In one implementation of module 230, a color-coding scheme is used to depict particular types of connections in the first view. For example, in a first view of nodes and connections representing a corpus of art history knowledge, blue might be used to depict connections between nodes representing artworks by the same artist. In another implementation of module 230, audio, visual, or audio-visual sounds, icons, or other indicators or combinations of indicators are used to depict particular types of connections in the first view or a particular path among connections in the first view.

Module 230 organizes nodes and their connections according to a multi-dimensional weighting system or scheme. In one implementation of module 230, one dimension of a multi-dimensional weighting system is time, enabling node organization according to when the item represented by a node was created or modified, when the node itself was created or modified, or another time-based organizational scheme.

In module 230, the first view organizes nodes and their connections in a three-dimensional arrangement around a user in a VR environment. Some non-limiting examples of three-dimensional arrangements are the presently available dandelion, spherical, and galaxy or nebula arrangement. For example, in a first view of nodes and connections representing a corpus of art history knowledge, nodes representing artworks might be depicted at distances in the VR environment from a user, with the distances corresponding to the age of the artworks. Thus, a depiction of a node representing a cave painting might appear to be furthest away from a user, a depiction of a node representing a classical Greek sculpture might appear to be in a medium distance from the user, and a depiction of a node representing a movie finished last week might appear to be closest of the three representations to the user.

In some implementations of module 230, the first view is organized according to a use case. Some non-limiting examples of uses case are a user's role definition (e.g., knowledge curator, knowledge owner, knowledge designer, knowledge consumer), a security or access management category of the user or data in the corpus of knowledge, a training use case, a consulting use case, a brainstorming use case, and a use case involving a collaboration between two or more users.

Gesture detection module 220 uses one or more gesture recognition sensors and a presently available technique to detect a gesture performed by a user. One non-limiting example of a presently available gesture is a user moving her physical hand until a virtualized image of two fingers of her hand touches an image representing a node, and moving her physical hand to drag the image to a desired location in the VR environment. Other finger-based gestures, such as selecting, dragging, zooming in (by expanding a distance between a thumb and another finger), zooming out (by shortening a distance between a thumb and another finger), and three-finger gestures recognized using a trackpad or another gesture recognition sensor, are also presently available. One implementation of module 220 recognizes a two-handed gesture, in which moving a pinched-together thumb and another finger, in each hand, apart from each other invokes a zoom in and moving a pinched-together thumb and another finger, in each hand, towards each other invokes a zoom out. A pinched-together thumb and finger refers to a configuration in which a thumb is held in contact with another finger of the same hand. Another implementation of module 220 recognizes a one-handed gesture, in which rotating a hand from an open palm-down position to an open palm-up position invokes a guidance or help function described elsewhere herein. Other gestures, and the commands such gestures invoke, are also possible.

View generation module 230 adjusts the first view of the graph, resulting in a second view of the graph in the VR environment. In an embodiment, the adjusting causes a change in a subset of the set of nodes, causing a representation, in the VR environment, of a node to change to a new representation of the node, or causing a representation, in the VR environment, of a connection to change to a new representation of the connection. In one implementation of module 230, the adjusting causes a new representation of a node, indicative of a different level of detail (i.e., more detail or less detail) of the node from the initial representation of the node. For example, in a “zoomed in” state, the most important nodes based on the current context might be displayed at a higher level of detail, while the rest of the nodes might be displayed at a lower level of detail. As another example, in a “zoomed out” state, most of the nodes might be displayed at an intermediate (i.e., between high and low) level of detail.

To determine the relative information level for a node for a given zoom level, module 230 analyzes the context of the current node representation, including the user's previous interactions, the current focus area, and the overall structure of the knowledge graph. This analysis helps determine the nodes most relevant to the user's current task or query. In particular, module 230 assigns an importance score to one or more nodes in the knowledge graph based on various factors, such as the node's centrality in the graph, the node's frequency of access or interaction by the user or a subset of all the embodiment's users, and the relevance of the node's content to the user's current query or interest. The node importance score prioritizes which nodes have the highest displayed detail. To incorporate a node's frequency and recency of access by a user, module 230 weights node access data using a weighted moving average (WMA) algorithm to emphasize more recent interactions. In particular, module 230 computes a WMA value at a particular time t by dividing the sum (for all i from 1 to n) of all wᵢxᵢ by the sum (for all i from 1 to n) of all wᵢ, where wᵢ represents the interaction data points, xᵢ represents the weights (with more recent interactions given higher weights), and n is the number of data points. To determine a user's current focus area, module 230 examines the specific part of the knowledge graph that the user is currently exploring, including tracking the user's navigation path and identifying clusters of nodes that are closely related to the user's current focus using the presently available Louvain method for community detection in networks. The Louvain method computes (½m)*sum([Aᵢⱼ−kᵢkⱼ/2m)*δ(Cᵢ, Cⱼ)), where Aᵢⱼ is an adjacency matrix storing adjacency of nodes in the knowledge graph, kᵢ and kⱼ are the degrees of nodes i and j, m is the number of edges, Cᵢ and Cⱼ are the communities of nodes i and j, δ( ) represents the Kronecker delta function, and sum( ) is the summation function, for all i and j. To perform task and query analysis, module 230 considers the user's current task or query context, such as a search query, the type of analysis being performed, or specific learning objectives of the user. One implementation of module 230 uses a presently available term frequency-inverse document frequency (TF-IDF) algorithm to identify relevant nodes. To compute a node importance score, implementations of module 230 use presently available graph theory metrics such as degree centrality, betweenness centrality, and closeness centrality to determine the structural importance of each node within the graph. For example, betweenness centrality C_{B}(v) is calculated as the sum of σₛₜ(v)/σₛₜ, for all s not equal to t not equal to v, where σₛₜ is the total number of shortest paths from node s to t, and σₛₜ(v) is the number of those paths that pass through node v. Another implementation of module 230 calculates an importance score based on how often each node has been accessed or interacted with by users. Nodes with higher interaction frequencies are considered more important. Another implementation of module 230 uses a presently available machine learning algorithm such as a support vector machine, to assess the relevance of a node based on content similarity, by content represented by the node, to a user's query or area of interest.

Module 230 maps the calculated node importance scores to different levels of detail based on the current zoom level of the graph representation. For instance, at a high zoom level (zoomed out), only the most critical nodes and their primary connections are shown. At a low zoom level (zoomed in), more detailed information about each node, including secondary connections and metadata, is displayed. In one implementation of module 230, as a user zooms in, additional details such as node metadata, secondary connections, and related content are incrementally revealed using a logarithmic scale function, for example DetailLevel(z)=log(1+β_{z}), where z is the zoom level and β is a scaling factor. Module 230 periodically adjusts the detail level of the nodes as the user zooms in or out, ensuring that the most relevant information is always prominently displayed. One implementation of module 230 performs node importance scoring and view adjustment in real time, in response to a detected user gesture detected by the VR system or other user input. One implementation of module 230 allows a user to customize the criteria for determining node importance and information levels, and specify preferences for how information is displayed. Module 230 incorporates user feedback to refine importance scoring and detail level mapping. For example, one implementation of module 230 utilizes one or more presently available supervised or unsupervised learning techniques, such as k-means clustering, to analyze patterns in user interactions with the knowledge graph. To render the three-dimensional graph in the VR environment, one implementation of module 230 uses a presently available visualization engine able to render a knowledge graph with thousands of nodes and connections in real time or near real time.

In another implementation of module 230 the new representation of the node is indicative of a change in status of the node (e.g., more data relating to the node has been added to the corpus). In another implementation of module 230, the adjusting causes a new representation of a connection, indicative of a change in a status of the connection. In one implementation of module 230, a change in a status of the connection has occurred because a new connection has been formed between nodes, or more data relating to the connection has been added to the corpus. In another implementation of module 230, a change in a status of the connection has occurred due to a navigational inference, such as a user's node-to-node traversal history in the graph along connections including the connection, or navigation along the connection is being suggested by a user guidance function described elsewhere herein. In another implementation of module 230, the resulting view visually presents a result of an analysis, using a presently available technique and one or more presently available learning or navigation metrics, of the user's navigation through one or more nodes. In another implementation of module 230 the new representation of the node is indicative of a specific type of node. One implementation of module 230 defines specific rules for different content types within the nodes. For example, document nodes might reveal summaries or excerpts at intermediate zoom levels, while image nodes might show thumbnails or high-resolution versions. Another implementation of module 230 organizes content hierarchically, displaying higher-level categories or summaries at comparatively zoomed-out levels and detailed subcategories or full content at comparatively zoomed-in levels. One implementation of module 230 adjusts the visibility and detail level of nodes based on the user's role and access permissions. For example, administrators might see more comprehensive metadata and control options than non-administrators. One implementation of module 230 adjusts the node detail levels and connections displayed based on the user's specific tasks or roles, such as knowledge curation, data analysis, or content consumption. One implementation of module 230 uses visual cues such as highlighting, color coding, and size adjustments to emphasize the most important nodes at each zoom level. One implementation of module 230 provides interactive annotations and tooltips that offer additional context and information when the user hovers over or selects a node.

In one implementation of module 230, the second view of the graph in the VR environment is a result of merging two views or portions of views. In one implementation of module 230, a human expert (e.g., a knowledge facilitator), merges two views according to a desired outcome (e.g., a learning or brainstorming objected). In another implementation of module 230, a trained machine learning model uses a presently available technique to merge views based on the data represented in each view.

Module 230 adjusts the first view of the graph responsive to module 220 detecting a gesture. In implementations of modules 220 and 230, the gesture invokes selection of a node, a drag gesture repositioning a node within a virtual three-dimensional space representation in a VR environment, a navigation gesture along a connection, a user interface that activates when a user looks at his or her palm, with a particular action assigned to a particular location on the user's hand and activated by tapping the location, or another presently available gesture supported by a user interface. In another implementation of modules 220 and 230, the gesture is a two-handed gesture, invoking a zoom in or out, as described elsewhere herein. In another implementation of modules 220 and 230, an orientation of the gesture corresponds to an orientation along which a level of detail of one or more nodes is changed. In another implementation of modules 220 and 230, the gesture invokes a guidance or help function.

Guidance module 240 implements a user guidance or help function. In implementations of module 240, the user guidance function provides one or more of a connection creation function, a node or connection curation function, a node or connection rearrangement function, a tour guide function, a function generating a summary or context of content or datasets represented by nodes along a traversed path or within a defined portion of the system, an import function including recommending and forming new nodes and connections representing imported data, a merge function merging nodes and connections representing two corpuses of knowledge, and a conflict resolution function resolving import and merge conflicts. In one implementation of module 240, the user guidance function includes an animation function that, when invoked, indicates a node, a relationship between nodes, a next node recommendation from a currently selected node, or another animation guiding a user in exploration of the nodes and connections based on a user-defined criterion. In one implementation of module 240, a user preference setting controls a degree of scriptedness versus randomness provided by the user guidance function's recommendations. For example, if the user preference setting is set to the maximum scriptedness value, the user guidance function's recommendations might include only the most likely recommendation, based on the user's or a group of other users' past actions. On the other hand, if the user preference setting is set to the minimum scriptedness value (i.e., maximum randomness), the user guidance function's recommendations might include only randomly generated recommendations, generated using a pseudo-random number generator, a presently available technique. In implementations of module 240, a user or machine learning model sets the user preference setting.

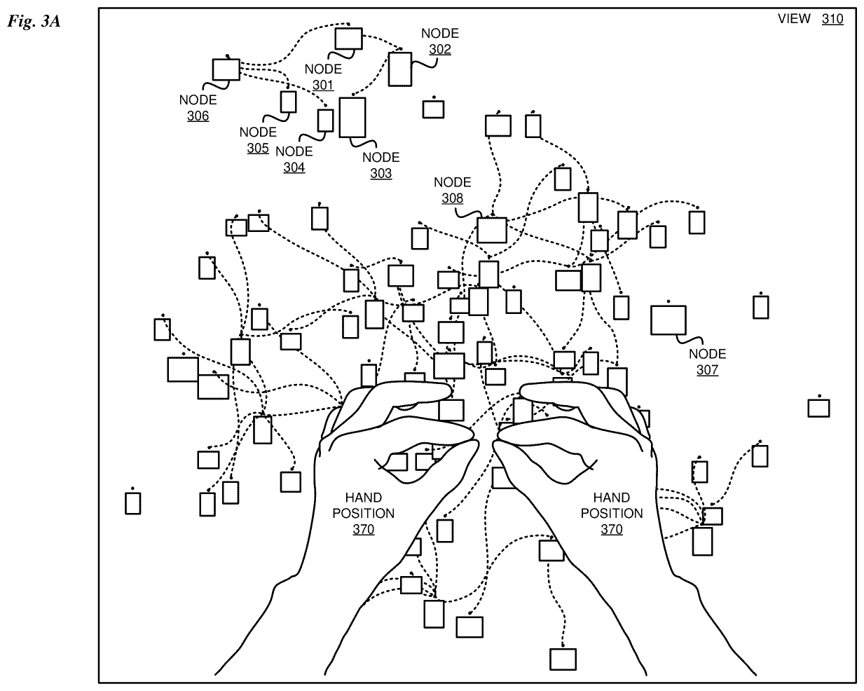

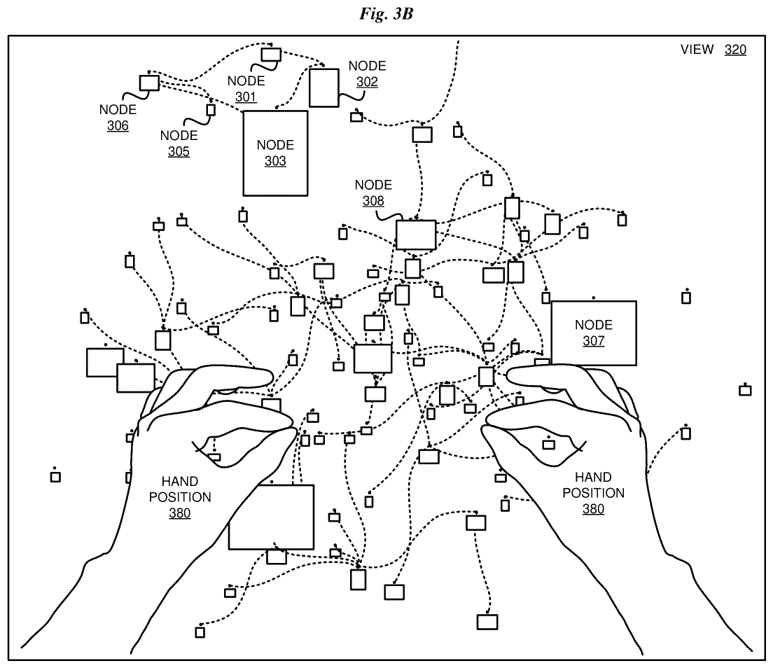

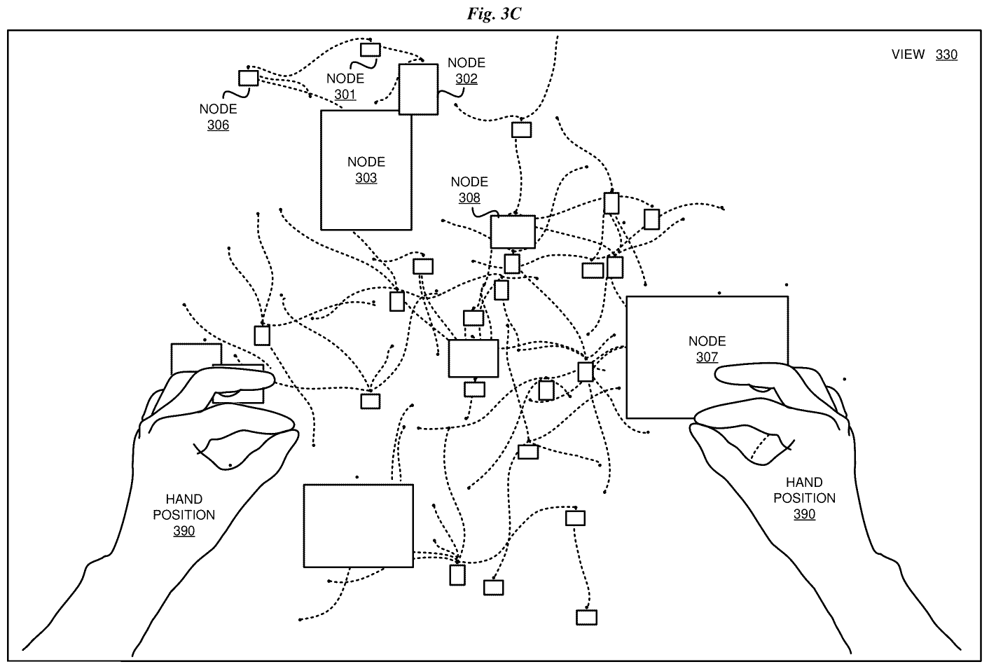

With reference to FIG. 3A, this figure depicts a first phase of an example of knowledge representation and management in a virtual reality environment in accordance with an illustrative embodiment. The example can be executed using application 200 in FIG. 2.

View 310 is an example view of a graph representing a corpus of knowledge. Although view 310 would normally be presented visually, in a virtual three-dimensional space representation in a virtual reality (VR) environment, for example purposes view 310 is depicted two-dimensionally. View 310 includes nodes 301, 302, 303, 304, 305, 306, 307, and 308, as well as additional nodes and connections between nodes. Nodes 301, 302, 303, 304, 305, 306, 307, and 308 in view 310 are depicted at a first level of detail. Hand positions 370 depict a starting point of a two-handed gesture, in which moving a pinched-together thumb and another finger, in each hand, apart from each other invokes a zoom in and moving a pinched-together thumb and another finger, in each hand, towards each other invokes a zoom out.

With reference to FIG. 3B, this figure depicts a second phase of an example of knowledge representation and management in a virtual reality environment in accordance with an illustrative embodiment. Nodes 301, 302, 303, 305, 306, 307, and 308 are the same as nodes 301, 302, 303, 305, 306, 307, and 308 in FIG. 3A.

View 320 is an example view of a graph representing a corpus of knowledge, adjusted from view 310 as a result of hand position 370 changing to hand position 380, in which the hands are further apart than in hand position 370 in FIG. 3A. As a result, in view 320 the sizes of nodes 303 and 307 have been enlarged with respect to the sizes of nodes 303 and 307 in FIG. 3A. As well, node 303 now obscures node 304 in view 310.

With reference to FIG. 3C, this figure depicts a third phase of an example of knowledge representation and management in a virtual reality environment in accordance with an illustrative embodiment. Nodes 301, 302, 303, 306, 307, and 308 are the same as nodes 301, 302, 303, 306, 307, and 308 in FIG. 3A.

View 330 is an example view of a graph representing a corpus of knowledge, adjusted from view 320 as a result of hand position 380 changing to hand position 390, in which the hands are further apart than in hand position 380 in FIG. 3B. As a result, in view 330 the sizes of nodes 303 and 307 have been enlarged with respect to the sizes of nodes 303 and 307 in FIG. 3B. As well, node 303 now obscures node 305 in view 330.

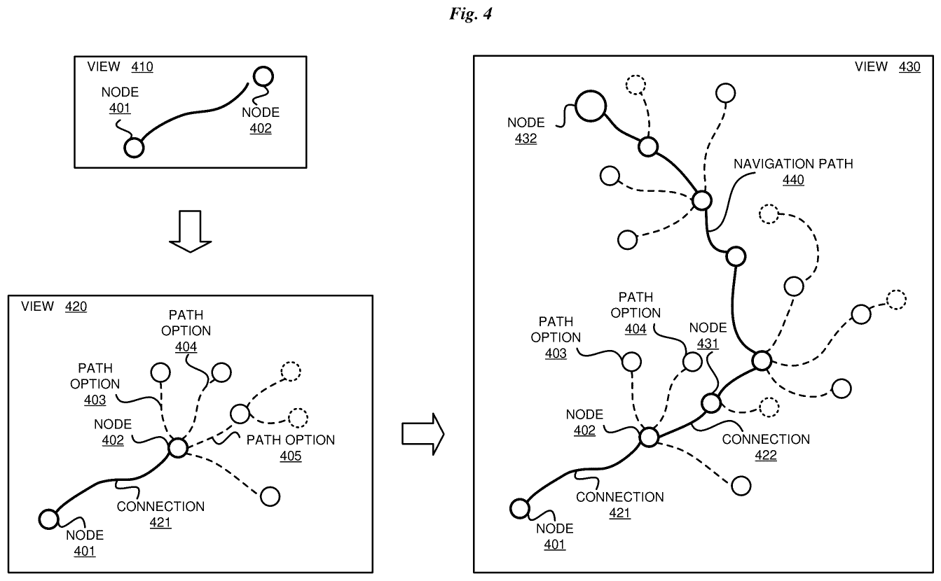

With reference to FIG. 4, this figure depicts another example of knowledge representation and management in a virtual reality environment in accordance with an illustrative embodiment. The example can be executed using application 200 in FIG. 2.

In particular, view 410 depicts a portion of a graph representing a corpus of knowledge. The graph includes nodes 401 and 402, as well as a connection being formed between nodes 401 and 402 as a user traverses from node 401 to 402 in view 410.

View 420 depicts a result of the user's traversal from node 401 to 402, forming connection 421. In a dandelion arrangement, path options 403, 404, and 405 are possible paths from node 402, depicted differently from connection 421 because a user has not yet selected one of path options 403, 404, and 405 (or another option, or no option). Path options 403, 404, and 405 serve as suggestions to a user of possible navigation paths.

View 430 depicts a result of the user's traversal from node 402 to node 431 (forming connection 422) and onward along navigation path 440 to node 432. In a dandelion arrangement, path options 403 and 404, as well as additional path options, are depicted differently from navigation path 440 because a user has not yet selected one of these path options.

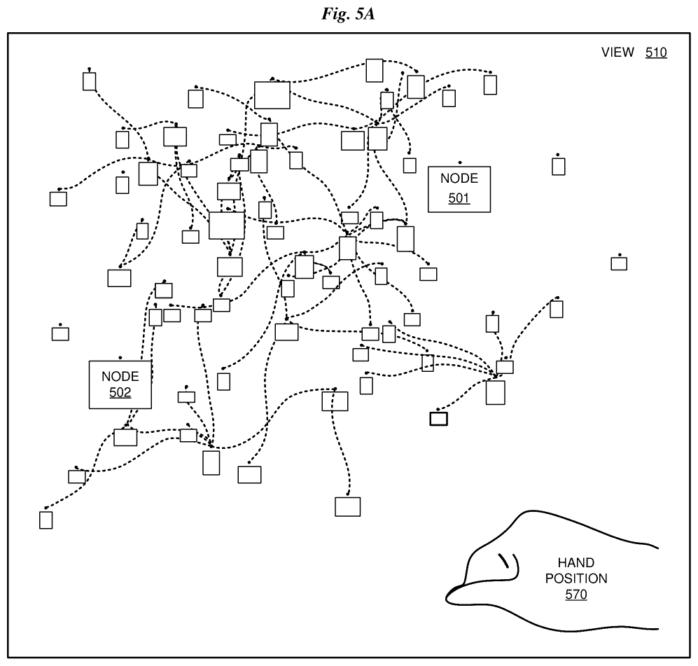

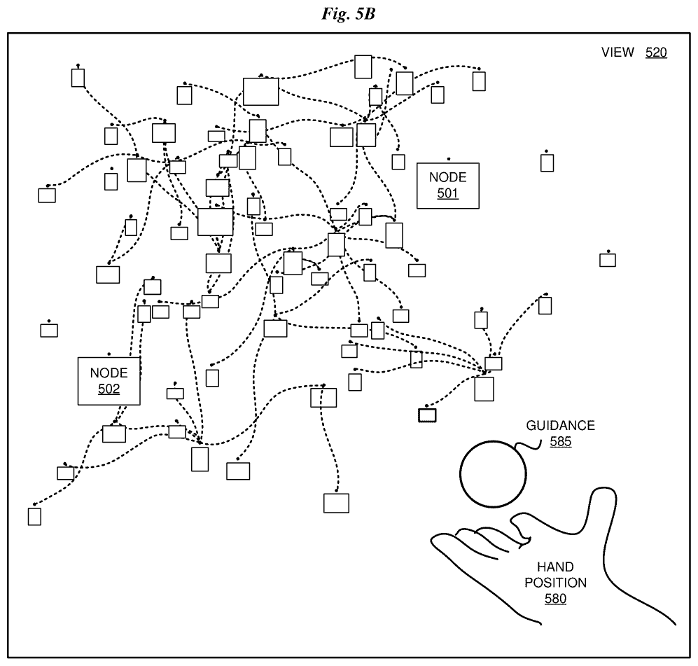

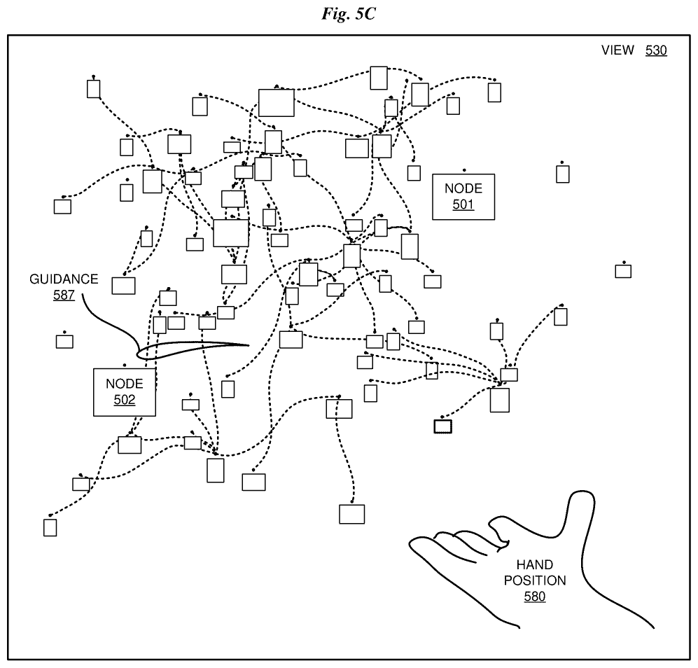

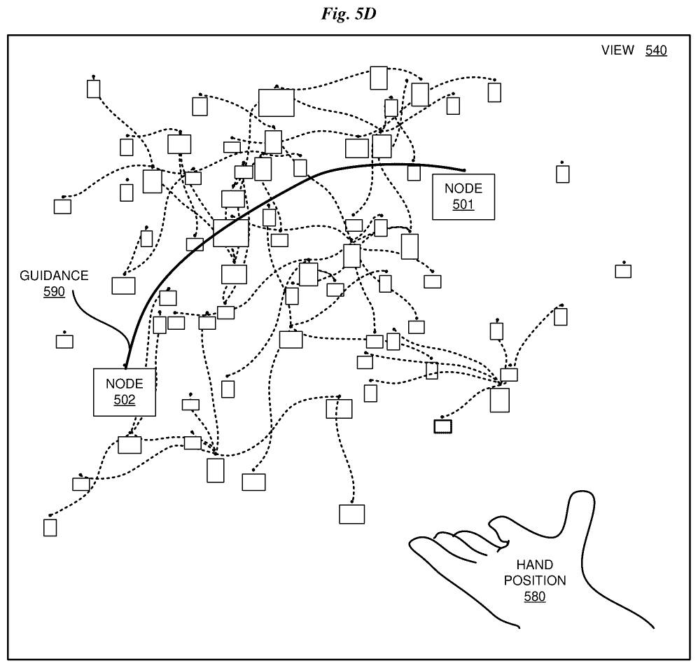

With reference to FIG. 5A, this figure depicts a first phase of another example of knowledge representation and management in a virtual reality environment in accordance with an illustrative embodiment. The example can be executed using application 200 in FIG. 2.

View 510 is an example view of a graph representing a corpus of knowledge. Although view 510 would normally be presented visually, in a virtual three-dimensional space representation in a virtual reality (VR) environment, for example purposes view 510 is depicted two-dimensionally. View 510 includes nodes 501 and 502. Hand position 570 depict a starting point of a one-handed gesture invoking a guidance or help function.

With reference to FIG. 5B, this figure depicts a second phase of another example of knowledge representation and management in a virtual reality environment in accordance with an illustrative embodiment. Nodes 501 and 502 are the same as nodes 501 and 502 in FIG. 5A.

View 520 is an example view of a graph representing a corpus of knowledge, adjusted from view 510 as a result of hand position 570 changing to hand position 580, invoking a guidance or help function. As a result, guidance 585 has been activated.

With reference to FIG. 5C, this figure depicts a third phase of another example of knowledge representation and management in a virtual reality environment in accordance with an illustrative embodiment. Nodes 501 and 502, and hand position 580, are the same as nodes 501 and 502, and hand position 580, in FIG. 5B.

View 530 is an example view of a graph representing a corpus of knowledge, adjusted from view 520. In particular, in view 530 guidance 585 has been transformed into guidance 587, swooping towards node 502.

With reference to FIG. 5D, this figure depicts a fourth phase of another example of knowledge representation and management in a virtual reality environment in accordance with an illustrative embodiment. Nodes 501 and 502, and hand position 580, are the same as nodes 501 and 502, and hand position 580, in FIG. 5B.

View 540 is an example view of a graph representing a corpus of knowledge, adjusted from view 530. In particular, in view 540 guidance 587 has been transformed into guidance 590, suggesting a relationship (and hence a connection) from node 502 to node 501.

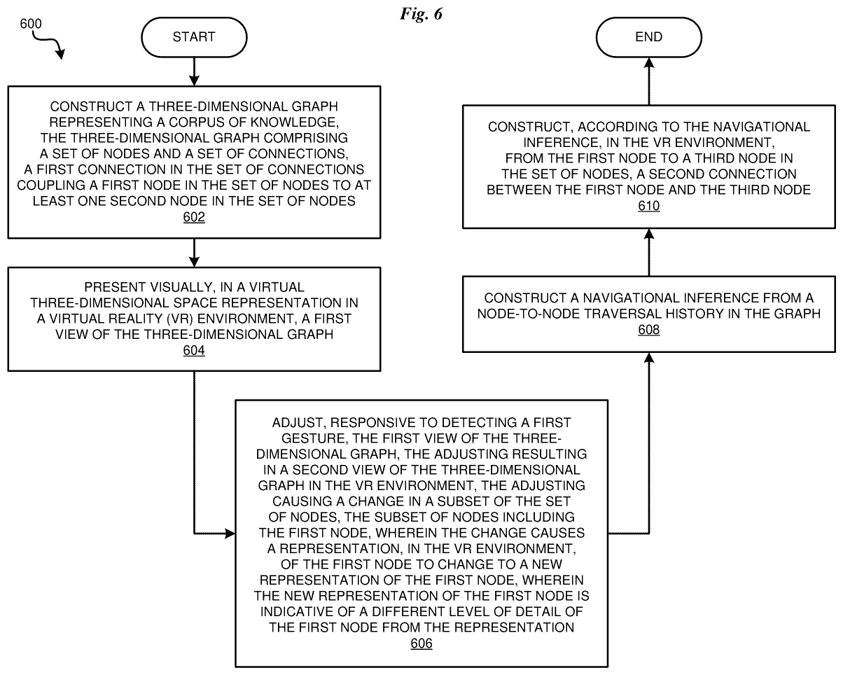

With reference to FIG. 6, this figure depicts a flowchart of an example process for knowledge representation and management in a virtual reality environment in accordance with an illustrative embodiment. Process 600 can be implemented in application 200 in FIG. 2.

In the illustrated embodiment, at block 602, the process constructs a three-dimensional graph representing a corpus of knowledge, the three-dimensional graph comprising a set of nodes and a set of connections, a first connection in the set of connections coupling a first node in the set of nodes to at least one second node in the set of nodes. At block 604, the process presents visually, in a virtual three-dimensional space representation in a virtual reality (VR) environment, a first view of the three-dimensional graph. At block 606, the process adjusts, responsive to detecting a first gesture, the first view of the three-dimensional graph, the adjusting resulting in a second view of the three-dimensional graph in the VR environment, the adjusting causing a change in a subset of the set of nodes, the subset of nodes including the first node, wherein the change causes a representation, in the VR environment, of the first node to change to a new representation of the first node, wherein the new representation of the first node is indicative of a different level of detail of the first node from the representation. At block 608, the process constructs a navigational inference from a node-to-node traversal history in the graph. At block 610, the process constructs, according to the navigational inference, in the VR environment, from the first node to a third node in the set of nodes, a second connection between the first node and the third node. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
constructing a three-dimensional graph representing a corpus of knowledge, the three-dimensional graph comprising a set of nodes and a set of connections, a first connection in the set of connections coupling a first node in the set of nodes to at least one second node in the set of nodes;
presenting visually, in a virtual three-dimensional space representation in a virtual reality (VR) environment, a first view of the three-dimensional graph; and
adjusting, responsive to detecting a first gesture, the first view of the three-dimensional graph, the adjusting resulting in a second view of the three-dimensional graph in the VR environment, the adjusting causing a change in a subset of the set of nodes, the subset of nodes including the first node, wherein the change causes a representation, in the VR environment, of the first node to change to a new representation of the first node, wherein the new representation of the first node is indicative of a different level of detail of the first node from the representation.

2. The computer-implemented method of claim 1, wherein the different level of detail is greater than a first level of detail of the first node prior to the first gesture.

3. The computer-implemented method of claim 1, wherein the different level of detail is less than a first level of detail of the first node prior to the first gesture.

4. The computer-implemented method of claim 1, further comprising:
constructing a navigational inference from a node-to-node traversal history in the graph; and
constructing, according to the navigational inference, in the VR environment, from the first node to a third node in the set of nodes, a second connection between the first node and the third node.

5. The computer-implemented method of claim 1, wherein the first gesture comprises a two-handed gesture, the two-handed gesture comprising altering a distance between a left hand a right hand, each hand maintained with a thumb held in contact with another finger of the same hand.

6. The computer-implemented method of claim 1, wherein an orientation of the first gesture corresponds to an orientation along which a level of detail of the subset of nodes is changed in the second view.

7. The computer-implemented method of claim 1, further comprising:
generating, based on a user-defined criterion, a recommended traversal from the first node to a fourth node in the set of nodes.

8. The computer-implemented method of claim 7, wherein generating the recommended traversal is controlled by a user preference setting controlling a degree of scriptedness of the recommended traversal.

9. The computer-implemented method of claim 7, wherein the recommended traversal is generated responsive to detecting a second gesture.

10. The computer-implemented method of claim 9, wherein the second gesture comprises rotating a hand from an open palm-down position to an open palm-up position.

11. A computer program product comprising one or more computer readable storage media, and program instructions collectively stored on the one or more computer readable storage media, the program instructions executable by a processor to cause the processor to perform operations comprising:
constructing a three-dimensional graph representing a corpus of knowledge, the three-dimensional graph comprising a set of nodes and a set of connections, a first connection in the set of connections coupling a first node in the set of nodes to at least one second node in the set of nodes;
presenting visually, in a virtual three-dimensional space representation in a virtual reality (VR) environment, a first view of the three-dimensional graph; and
adjusting, responsive to detecting a first gesture, the first view of the three-dimensional graph, the adjusting resulting in a second view of the three-dimensional graph in the VR environment, the adjusting causing a change in a subset of the set of nodes, the subset of nodes including the first node, wherein the change causes a representation, in the VR environment, of the first node to change to a new representation of the first node, wherein the new representation of the first node is indicative of a different level of detail of the first node from the representation.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the different level of detail is greater than a first level of detail of the first node prior to the first gesture.

15. The computer program product of claim 11, wherein the different level of detail is less than a first level of detail of the first node prior to the first gesture.

16. The computer program product of claim 11, further comprising:
constructing a navigational inference from a node-to-node traversal history in the graph; and
constructing, according to the navigational inference, in the VR environment, from the first node to a third node in the set of nodes, a second connection between the first node and the third node.

17. The computer program product of claim 11, wherein the first gesture comprises a two-handed gesture, the two-handed gesture comprising altering a distance between a left hand a right hand, each hand maintained with a thumb held in contact with another finger of the same hand.

18. The computer program product of claim 11, wherein an orientation of the first gesture corresponds to an orientation along which a level of detail of the subset of nodes is changed in the second view.

19. The computer program product of claim 11, further comprising:
generating, based on a user-defined criterion, a recommended traversal from the first node to a fourth node in the set of nodes.

20. A computer system comprising a processor and one or more computer readable storage media, and program instructions collectively stored on the one or more computer readable storage media, the program instructions executable by the processor to cause the processor to perform operations comprising:
constructing a three-dimensional graph representing a corpus of knowledge, the three-dimensional graph comprising a set of nodes and a set of connections, a first connection in the set of connections coupling a first node in the set of nodes to at least one second node in the set of nodes;
presenting visually, in a virtual three-dimensional space representation in a virtual reality (VR) environment, a first view of the three-dimensional graph; and
adjusting, responsive to detecting a first gesture, the first view of the three-dimensional graph, the adjusting resulting in a second view of the three-dimensional graph in the VR environment, the adjusting causing a change in a subset of the set of nodes, the subset of nodes including the first node, wherein the change causes a representation, in the VR environment, of the first node to change to a new representation of the first node, wherein the new representation of the first node is indicative of a different level of detail of the first node from the representation.
